(19) United States
(12) Patent Application Publication
(10) Pub. No.: US 2014/0069853 A1
(43) Pub. Date: Mar. 13, 2014

(54) PLASMA ADVANCED WATER TREATMENT APPARATUS

(71) Applicants: Jae Hyeok Lee, Incheon (KR); JARWON ELECTRONICS CO., LTD., Bucheon-si, Gyeonggi-do (KR)

(72) Inventors: Jae Hyeok Lee, Incheon (KR); Min Ki Lee, Seoul (KR)

(73) Assignee: JARWON ELECTRONICS CO., LTD., Bucheon-si, Gyeonggi-do (KR)

(21) Appl. No.: 13/983,354

(22) PCT Filed: Mar. 22, 2012
(86) PCT No.: PCT/KR2012/002051

§ 371 Date: Aug. 2, 2013

(30) Foreign Application Priority Data
Mar. 22, 2011 (KR) 10-2011-0025487

(51) Int. Cl. C02F 1/467

(52) U.S. Cl. CPC C02F 1/4672
USPC 210/149; 210/205; 210/143

(57) ABSTRACT

A plasma advanced water treatment apparatus includes a double pipe having a first passage for treated water and a second passage for radical reaction gas, which are separated from each other; a plasma generating means including electrodes arranged at the first and second passages of the double pipe, and a power supply unit connected with the electrodes; and a water tank connected with the double pipe so that the treated water and a radical generation source react with each other.

### BACKGROUND OF THE INVENTION

The present invention relates to a plasma advanced water treatment apparatus, which removes coliform bacillus or various bacteria by using plasma discharge, and also removes various non-biodegradable organics through a radical generation source, such as ozone.

A technology related to an advanced water treatment by using plasma or ozone includes Korean Utility Model Registration No. 0288954 (Aug. 31, 2002) entitled “Ozone Generating Apparatus”.

The registered invention suggests an ozone generator which simultaneously improves an ozone generation rate and has high power efficiency by providing the ozone generating apparatus simultaneously performing an ozone generating method using dielectric barrier discharge and an ultraviolet ozone generating method using an ultraviolet ray source in one ozone generating unit.

However, it is considerably difficult to apply the registered invention to a water treatment field in terms of practicability, and particularly, the registered invention does not suggest a solution (both a high pressure wireless discharging method and an ultraviolet ray method generate heat) for a problem in that yield of ozone is remarkably degraded at a room temperature or higher.

Further, Korean Patent No. 0572514 (Apr. 13, 2006) discloses “Simultaneous Generator of Dissolved Ozone and Hydrogen Peroxide by Using Wet-Plasma in Water”, and the registered patent suggests an apparatus which increases the amount of dissolved ozone applied as a significant factor of an oxidation reaction in water and simultaneously generates hydrogen peroxide capable of improving a rate of autolysis of dissolved ozone in water by generating wet plasma in a region in which gas, liquid, and solid co-exist by using a high-frequency power source.

However, the registered patent also fails to suggest a solution for a problem in that yield of ozone is remarkably decreased at a room temperature or higher, and may be appropriate to a small-scale water treatment, such as a purifying facility for home, but is not appropriate to a large-scale water treatment.

Further, Patent Registration No. 0797027 (Jan. 16, 2008) discloses “Apparatus for Wastewater Treatment by Using Ultraviolet Light and Oxidative Species Produced in Dielectric Barrier Discharge Tube, and Method of Wastewater Treatment Using the Same”, and suggests the wastewater treatment apparatus including a dielectric barrier discharge tube formed of a metal rod and a quartz pipe surrounding the metal rod, a high voltage generator provided at an upper end of the discharge tube, and a cylindrical photo catalyst network around the discharge tube and inside the wastewater treatment apparatus.

The registered patent cites an effect of ultimately removing organics with little electricity and high efficiency in a simple reaction device by providing an apparatus and a method capable of treating organics by two or more mechanisms, in which various oxidative components and ultraviolet rays are generated by generating electrical discharge inside the dielectric barrier discharge tube containing waste water, the organics within the waste water is oxidized and removed by dispersing the oxidative components in the waste water in a microbubble form, and simultaneously the organics are removed by activating the photo catalyst or directly irradiating the waste water by using the ultraviolet rays discharged from the dielectric barrier discharge tube.

However, the registered patent is disadvantageous in view of a fact that a treatment capacity basically depends on a size of the dielectric barrier tube, and needs to secure a residence time, so that the registered patent seems to be inappropriate to water treatment use for flowing water.

Further, Patent No. 0833814 (May 26, 2008) discloses a “Water Purifying Apparatus”, which has high-level water purifying performance by using a process of combining a peroxy radical and ozone, thereby improving water purifying performance, and which simultaneously performs the generation of a peroxy radical and the purification of water at the same space, thereby decreasing a water purifying cost compared to a water purifying apparatus by an ozone-alone process in the related art.

However, the registered patent has nothing to do with a guarantee of a yield of ozone or a large capacity water treatment technique.

### SUMMARY OF THE INVENTION

An object of the present invention is to provide a plasma advanced water treatment apparatus, which removes colon bacillus and various bacteria by using a plasma discharge, adopts plasma discharging electrodes in a double pipe including a first passage for water-to-be treated and a second passage for radical reaction gas so that various non-biodegradable organics may be removed through a radical generation source, such as ozone, a contact reaction between contaminated water-to-be-treated, which is plasma discharge processed in a water tank provided at the outside and the radical generation source, such as ozone, thereby guaranteeing a perfect water treatment.

Another object of the present invention is to provide a plasma advanced water treatment apparatus, in which the first passage is filled with a plurality of dielectric beads, and the dielectric beads randomly move according to a collision with the passing water-to-be-treated to generate stable potential within the first passage, thereby more effectively removing various bacteria or various pathogenic bacteria.

Another object of the present invention is to provide a plasma advanced water treatment apparatus, which adopts a combined pipe connected with outlets of the first passage and the second passage of the double pipe, and a microbubble generating means including a pump disposed between the combined pipe and a water tank, thereby remarkably improving water treatment efficiency by improving efficiency of a contact between the water-to-be-treated and the radical generation source, such as ozone, and improving efficiency of dissolution of the radical generation source.

Another object of the present invention is to provide a plasma advanced water treatment apparatus, in which a plurality of double pipes is integrally arranged, and the double pipes are connected with a water tank, so that some of the water-to-be-treated repeatedly circulates the double pipes through a circulation pipe and some of the water-to-be-treated is discharged, thereby being applicable to a place requiring various capacities and water treatments from a small scale water treatment to a large scale water treatment for a water supply while improving water treatment efficiency. Further, in a case where it is desired to pretreat raw water in a relevant water treatment system or treat water, such as a neighboring lake, river, water system, and basin, a finally discharged low concentration ozone component may be used for treating the raw water, and a problem of residual ozone discharged after the water treatment may be solved by a method of destructing residual ozone by using active carbon, and the like, as other methods.

Another object of the present invention is to provide a plasma advanced water treatment apparatus, which adopts the spacer, so that it is not necessary to seal both ends of the internal pipe, thereby improving workability in filling the internal pipe with the dielectric beads and a product assembling property, in which the water-to-be-treated is supplied through a hose and treated water is discharged through the hose, thereby smoothly supplying the water-to-be-treated by decreasing fluid resistance by the dielectric beads, which is capable of uniformly supplying radical reaction gas to the respective double pipes when the radical reaction gas is simultaneously supplied to the plurality of double pipes, and which is capable of preventing fire due to overheating of the double pipe by blocking a power supply by a thermostat when the double pipe reaches a predetermined temperature or higher.

Another object of the present invention is to provide a plasma advanced water treatment apparatus, in which in a case where an internal pipe is damaged due to high pressure plasma discharge, the water-to-be-treated flowing from the damaged internal pipe is detected, and an operation of a power supply unit is stopped, so that it is possible to prevent fire or electrical shock due to a high voltage when a discharge tube is damaged, and when the water of the internal pipe of the double pipe leaks due to poor water tightness even though the discharge pipe is not damaged, it is possible to rapidly detect the leakage of the internal pipe of the double pipe, an insulated power voltage is supplied to a leakage detecting sensor and a photocoupler is provided between the leakage detecting sensor and a output stopping control circuit unit so that a current is insulated in a transformer and the photocoupler, so that it is possible to prevent a high plasma discharge voltage from flowing into a power supply unit even though the internal pipe is damaged, the double pipes are vertically arranged and the leakage detecting sensor is installed at the lower portions of the double pipes, so that it is perfectly detect damage and leakage in the internal pipe rapidly and without an error, and it is possible to prevent the water-to-be-treated existing in the internal pipe from flowing backward to a gas supply source even though the internal pipe is damaged.

In order to achieve the above object, the present invention provides a plasma advanced water treatment apparatus, including: a double pipe having a first passage for treated water and a second passage for radical reaction gas, which are separated from each other; a plasma generating means including electrodes arranged at the first and second passages of the double pipe, and a power supply unit connected with the electrodes; and a water tank connected with the double pipe so that the treated water and a radical generation source react with each other.

According to the plasma advanced water treatment apparatus according to the present invention, various non-biodegradable materials, colon bacillus, various bacteria, toxic materials in water, and the like may be removed by an intense electric field within the first passage by plasma discharge, an electrolyte generation by the electric field, plasma light energy by UV and the like generated at an outer circumferential surface of the first passage, an ozone generation by the plasma, and injected oxygen, it is possible to guarantee that contaminated water-to-be-treated, which is not treated within the water tank provided at the outside is completely treated by a contact reaction with ozone, radical, electrolyte, ion components in water, and the like generated within the plasma advanced water treatment apparatus having plasma discharge energy, and the ozone, the radical, the electrolyte, the ion components in water, and the like randomly move by dilution, collision, and the like with the water-to-be-treated passing through outer peripheral surfaces and surrounding areas of the plurality of filled dielectric beads within the first passage, thereby more effectively removing various bacteria, various colon bacillus, virus, non-biodegradable materials, and the like within the first passage. Further, it is possible to maximize dissolution efficiency and innovatively improving water treatment efficiency by improve efficiency of a contact between the water-to-be-treated and an ionic radical material, such as ozone, by introducing the combined pipe connected with each outlet of the first passage and the second passage of the double pipe, and the microbubble generating means including the pump for generating oxygen arranged between the combined pipe and the water tank for a contact, storage, and a water treatment, and further, the plasma advanced water treatment apparatus according to the present invention may be applied to from a small scale water treatment for home and to a large scale water treatment for water supply by improving water treatment efficiency by connecting the plurality of integrally arranged double pipes so that some of the water-to-be-treated repeatedly circulates the double pipe through the circulation pipe and some of the water-to-be-treated is discharged. Further, in a case where it is desired to pretreat raw water in a relevant water treatment system or treat water, such as a neighboring lake, river, water system, and basin, the finally discharged low concentration ozone component may be used for treating the raw water, so that most of all of the energy used in the plasma advanced water treatment apparatus is usable for a relevant water treatment, and as a method of treating other micro ozone, it is possible to easily remove residual micro ozone by using activated carbon, and the like.

Further, the present invention adopts the spacer, so that it is not necessary to seal both ends of the internal pipe, thereby achieving an effect of improving workability in filling the internal pipe with the dielectric beads and a product assembling property. Further, according to the present invention, the water-to-be-treated is supplied through the hose and the treated water is discharged through the hose, thereby achieving an effect of smoothly supplying the water-to-be-treated by decreasing fluid resistance by the dielectric beads, and it is possible to achieve an effect of uniformly supplying radical reaction gas to the respective double pipes when the radical reaction gas is simultaneously supplied to the plurality of double pipes, and it is possible to achieve an effect of preventing fire due to overheating of the double pipe by blocking a power supply by the thermostat when the double pipe reaches a predetermined temperature or higher.

Furthermore, according to the present invention, in a case where the internal pipe is damaged due to high pressure plasma discharge, the water-to-be-treated flowing out from the damaged internal pipe is detected to stop the operation of the power supply unit, thereby achieving an effect of preventing fire or electrical shock due to a high voltage when the discharge tube is damaged, and when the water of the internal pipe of the double pipe leaks due to poor water tightness even though the discharge pipe is not damaged, it is possible to achieve an effect of rapidly detecting the leakage of the internal pipe of the double pipe. Further, the insulated power voltage is supplied to the leakage detecting sensor and the photocoupler is provided between the leakage detecting sensor and the output stopping control circuit unit to insulate the current between the transformer and the photocoupler, so that it is possible to prevent a high plasma discharge voltage from flowing into the power supply unit even though the internal pipe is damaged, the double pipes are vertically arranged and the leakage detecting sensor is installed at the lower portions of the double pipes, so that it is perfectly detect damage and leakage in the internal pipe rapidly and without an error, and further it is possible to prevent the water-to-be-treated existing in the internal pipe from flowing backward to the gas supply source even though the internal pipe is damaged.

### BRIEF DESCRIPTION OF THE INVENTION

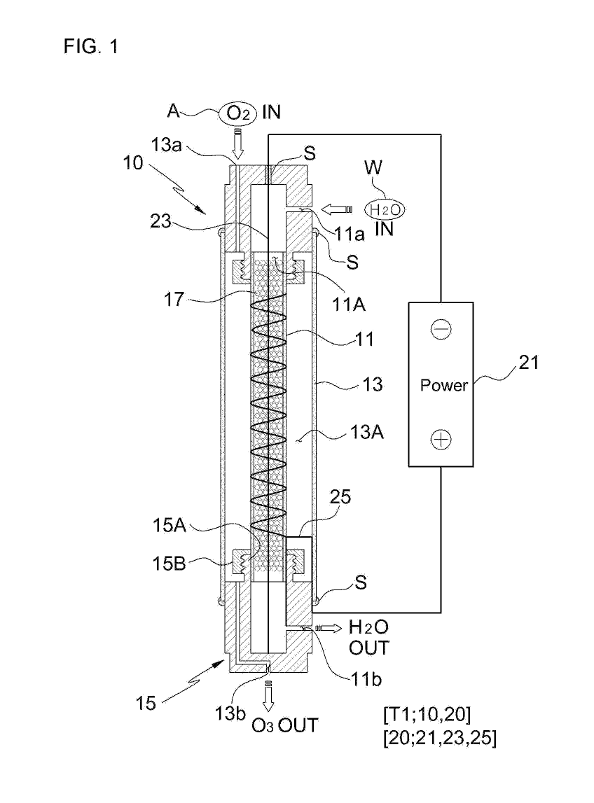

FIG. 1 is a schematic coupling cross-sectional view illustrating a double pipe and a plasma generating means of a plasma advanced water treatment apparatus according to the present invention.

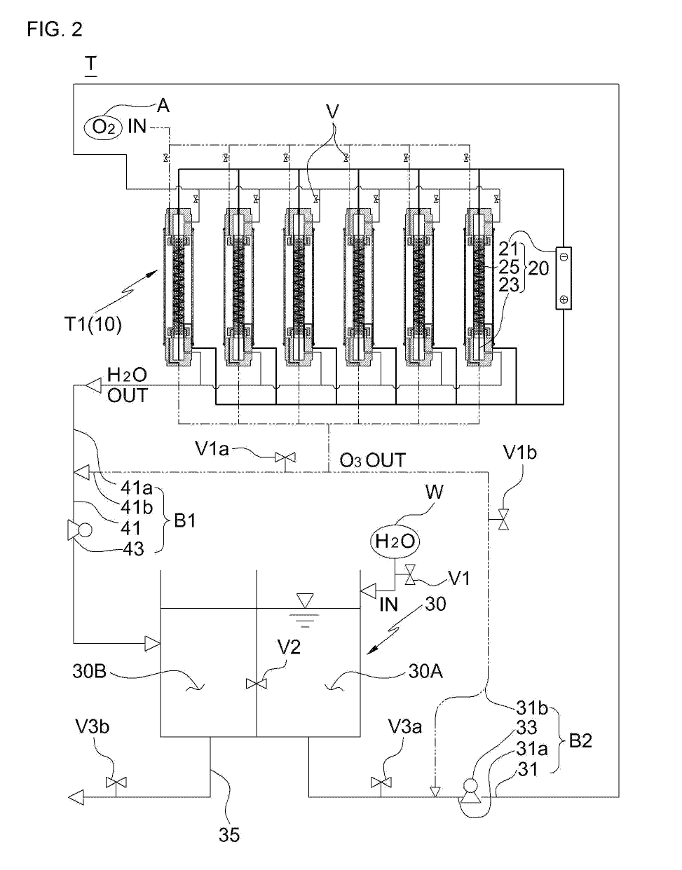

FIG. 2 is a schematic diagram in which the plasma advanced water treatment apparatus according to the present invention is disposed in a form appropriate to a middle and large scale water treatment.

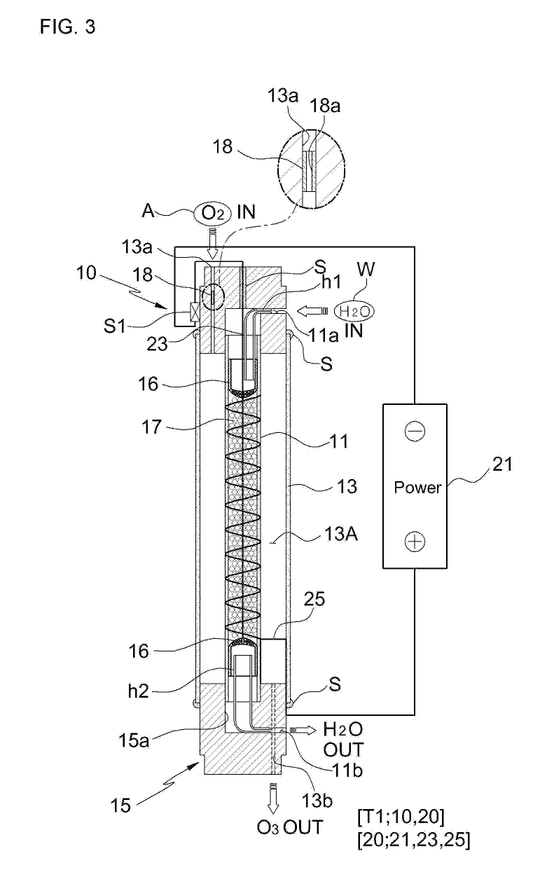

FIG. 3 is a schematic cross-sectional diagram of a plasma processing assembly formed of a double pipe and a plasma generating means in a plasma advanced water treatment apparatus according to another embodiment of the present invention.

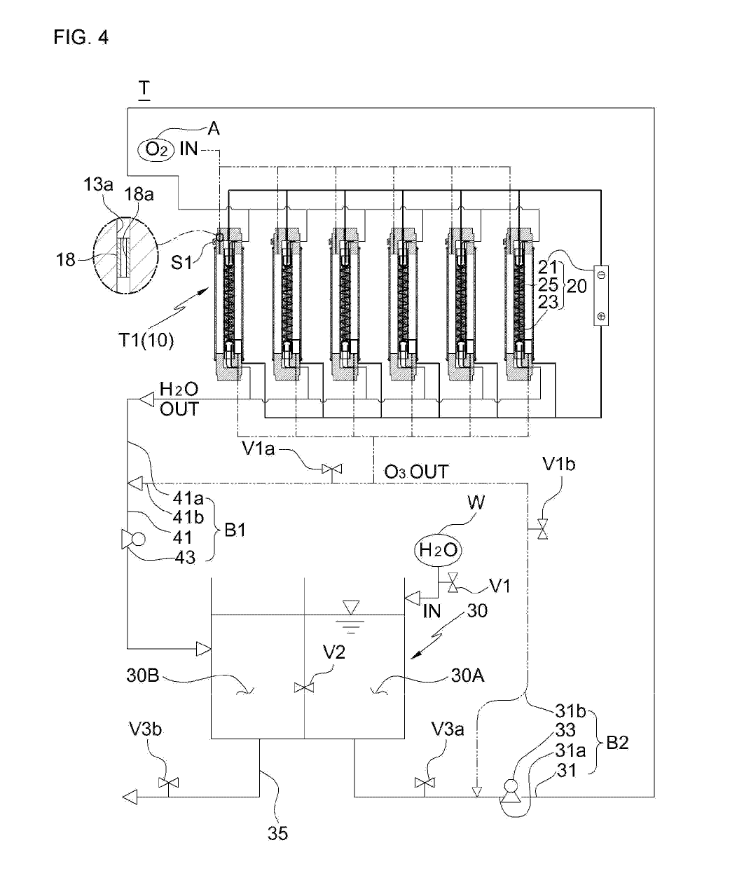

FIG. 4 is a schematic diagram in which the plasma advanced water treatment apparatus according to another embodiment of the present invention is disposed in a form appropriate to a middle and large scale water treatment.

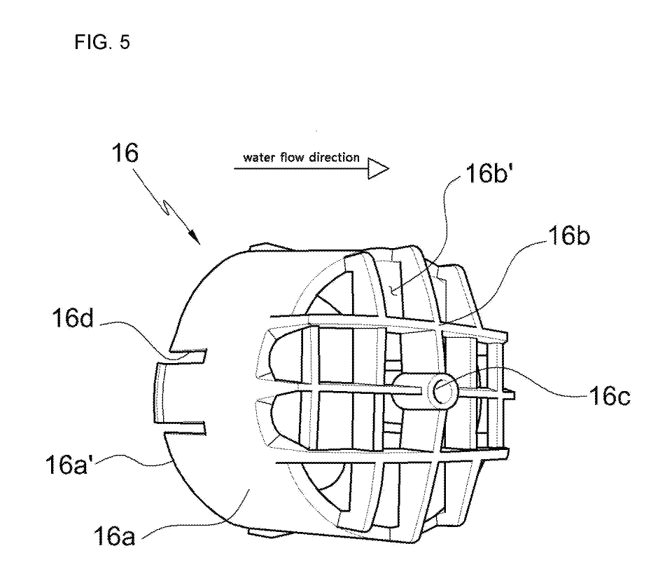

FIG. 5 is a perspective view illustrating a spacer in the plasma advanced water treatment apparatuses according to another embodiment of the present invention.

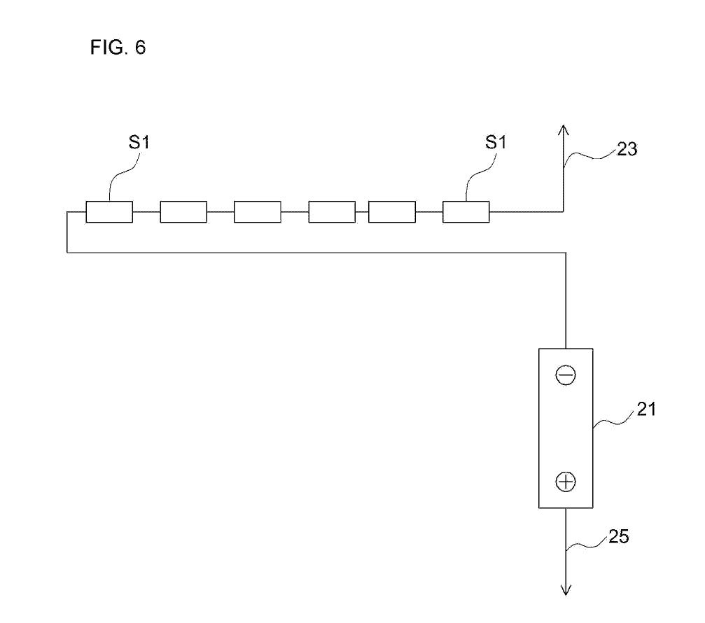

FIG. 6 is a connection wiring diagram in which a plurality of thermostats is serially connected to a plasma generating means in FIG. 4.

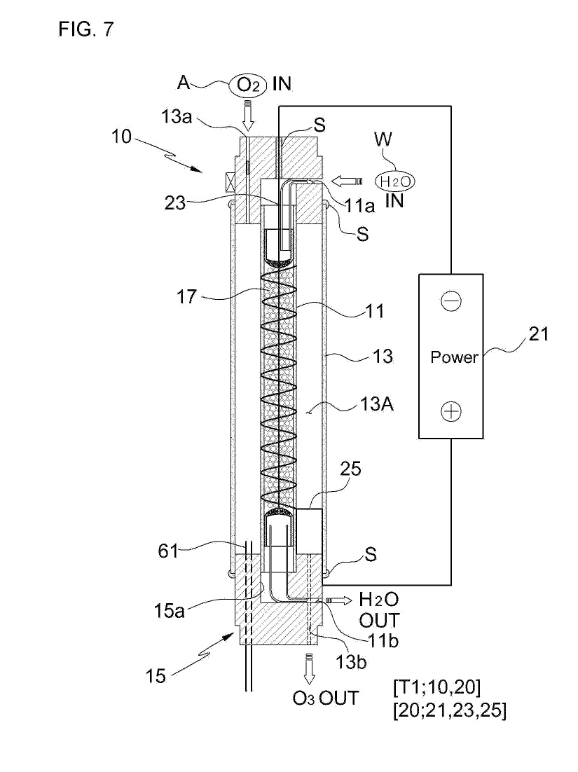

FIG. 7 is a schematic coupling cross-sectional view illustrating a double pipe and a plasma generating means which are principal elements of a plasma advanced water treatment apparatus according to yet another embodiment of the present invention.

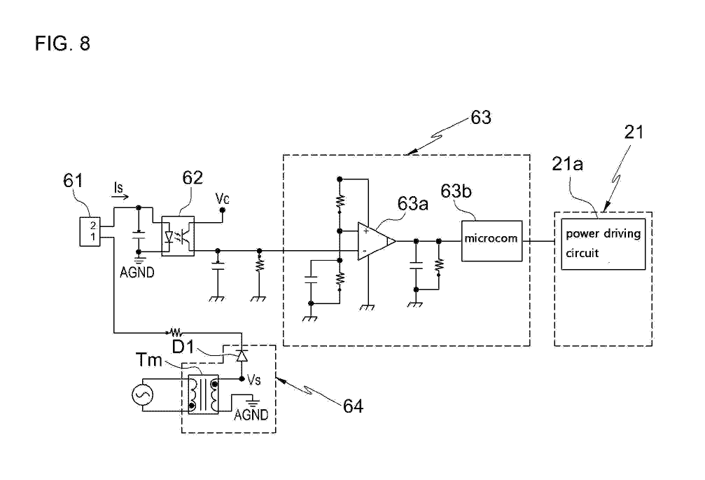

FIG. 8 is a circuit diagram for stopping an output of a power supply unit in a case where a leakage detecting sensor detects a leakage of a double pipe in the plasma advanced water treatment apparatus according to yet another embodiment of the present invention.

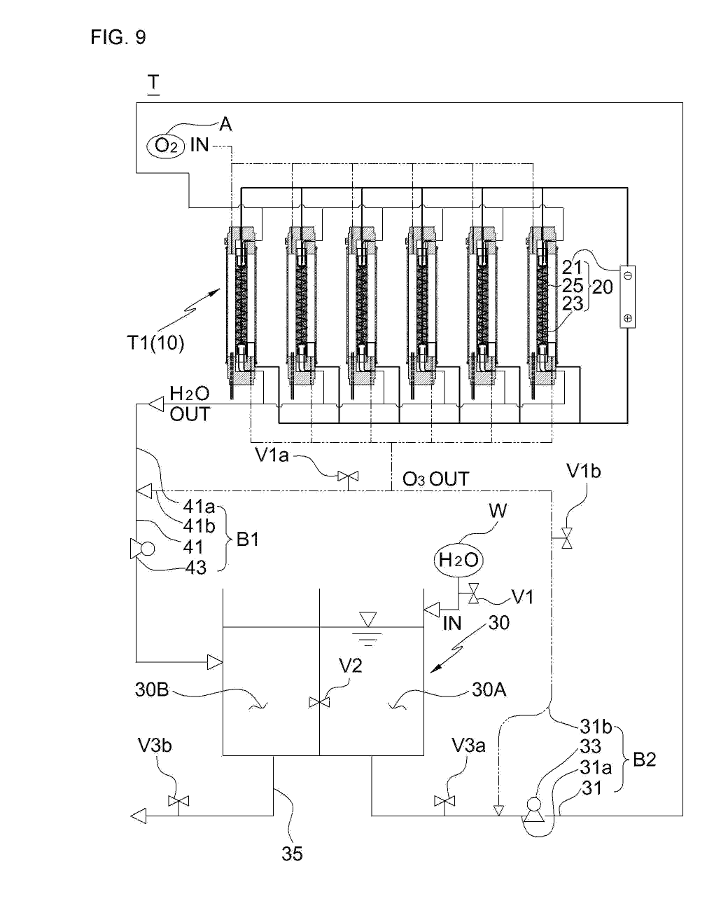

FIG. 9 is a schematic diagram in which the plasma advanced water treatment apparatus according to yet another embodiment of the present invention is disposed in a form appropriate to a middle and large scale water treatment.

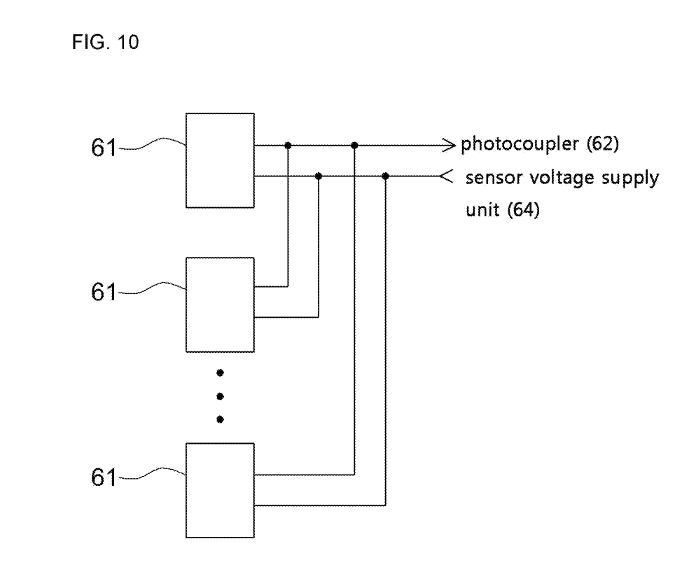

FIG. 10 is a principal circuit diagram in which a plurality of leakage detecting sensors is connected in parallel in FIG. 9.

### DETAILED DESCRIPTION OF THE INVENTION

Hereinafter, the present invention will be described in detail with reference to the accompanying drawing.

The present invention may be variously modified, and have various forms, so that implement examples will be described in detail below. However, it is not intended to limit the present invention to the specific embodiments, and it will be appreciated that the present invention includes all modifications, equivalences, or substitutions included in the spirit and the technical scope of the present invention.

In each drawing, the same reference numeral indicates a member having the same or similar function, and a member designated by each reference numeral in the drawing will be recognized as a member according to the reference unless otherwise particularly cited.

Further, in the drawings, for understanding and ease of description, the sizes or the thicknesses of the components are exaggerated to be large (or thick) or small (or thin), or simplified, but it shall not be construed that the scope of the present invention is limited thereto.

Terms used in the present application are used only to describe specific exemplary embodiments, and are not intended to limit the present invention. Singular expressions used herein include plurals expressions unless they have definitely opposite meanings. In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other specific characteristics, numbers, steps, operations, constituent elements, and components, or a combination thereof in advance.

All terms used herein including technical or scientific terms have the same meanings as meanings which are generally understood by those skilled in the art unless they are differently defined.

“First”, “second”, and the like described in the present specification are simply referred in order to discriminate different components, and is free of a manufactured order, and names thereof may not correspond to those in the detailed description and the claims of the invention.

As illustrated in FIGS. 1 and 2, a plasma advanced water treatment apparatus T according to an embodiment of the present invention generally includes a double tube 10 having first and second passages 11A and 13A, through which water-to-be-treated and radical reaction gas pass through, respectively, a plasma generating means 20, and a water tank 30 in which the water-to-be-treated and a radical generation source react with each other.

The plasma advanced water treatment apparatus T according to the present invention may be variously grafted for various small, middle, and large water treatment facilities, such as a minimum-unit water treatment apparatus, such as a water purifying facility for home, a middle and large scale water treatment apparatus appropriate to a rear end facility of a waster water treatment plant, and a water purifying facility for supplying tap water connected to a village unit well or supplying tap water in a large city. Further, the plasma advanced water treatment apparatus T according to the present invention is an apparatus available for remarkably improving a quality of water by removing algae existing lake water, a river, and the like, and oxidizing and removing various materials.

In the plasma advanced water treatment apparatus T according to the present invention, the plasma generating means has a primary goal of eradicating coliform bacillus, various bacteria, and other various pathogenic bacteria, and removing algae and harmful substances of a lake and a water system, and a radical generation source (such as, ozone) has a primary goal of decomposing and processing various non-biodegradable organics, toxic substances, and ecotoxicity in water.

Above all, the plasma advanced water treatment apparatus T according to the present invention is connected with a water source W of a water supply source, tap water, and a waste water treatment facility, so that the double pipe 10 is cooled in accordance with a water temperature even though heat is generated due to plasma discharge by water-to-be-treated newly and continuously supplied from the outside, thereby securing thermal stability of the radical generation source, such as ozone, vulnerable to a temperature and thus improving an ozone generating yield and treatment efficiency.

Particularly, the double pipe 10 includes an internal pipe 11, an external pipe 13, and both-end caps 15 for fixing the two pipes 11 and 13 in a state where the two pipes 11 and 13 are spaced apart from each other. The internal pipe 11 and the external pipe 13 may be formed of various glass materials, such as quartz glass or borosilicate glass of Pyrex™, and basically have an insulation property.

Fluids flowing through the first passage 11A and the second passage 13A may be randomly selected, but in the present invention, the first passage 11A of the internal pipe 11 is selected for allowing the water-to-be-treated to pass through in considering plasma discharge efficiency and convenience in introducing dielectric beads 17.

The internal pipe 11 is in external contact with a fitting part 15A of each cap 15, and when a fixing stopper 15B screw-engaged with the fitting part 15A is turned, the fitting part tightens the internal pipe, thereby simultaneously securing the fixing and a sealing property of the internal pipe. Various forms of packing ring may be introduced as necessary, and a method by which the internal pipe is tightened and in close contact with the fitting part 15A according to the tightening by the fixing stopper may be changed by adopting various publicly known pipe connecting joint structures.

Further, the external pipe 13 may be in a form which is in internal contact with each cap 15, and secure a sealing property through various sealing bodies S, such as a silicon resin. However, the external pipe 13 may adopt a fixing and sealing structure, such as an internal pipe fixing structure, by modifying the cap as necessary.

Further, the caps 15 are provided with an inlet 11a connected with various water sources W and an outlet 11b, and are provided with an inlet 13a connected with a gas supply source A (supply pure oxygen, air, and the like) supplying the radical reaction gas for forming the radical generation source, such as ozone, and an outlet 13b.

In the meantime, in the plasma advanced water treatment apparatus T according to the present invention, the plasma generating means 20 includes a power supply unit 21 (for example, supply power of around 4 kV), and first and second electrodes 23 and 25 connected with the power unit 21.

The first electrode 23 is a straight type disposed in the first passage 11A, and the second electrode 25 is a coil type disposed in the second passage 13A. However, various electrodes, such as a mesh type electrode or a dual coil type electrode, may be selectively introduced as necessary.

The first electrode 23 has a structure in which one end of the first electrode 23 is connected with the power supply unit 21 to be disposed at a center of the internal pipe 11 after passing through one cap 15, and the other end of the first electrode 23 is fitted to the other cap 15 to be supported.

Further, the second electrode 25 has a structure in which one end of the second electrode 25 is connected with the power supply unit 21 to be wound in a coil type while being in external contact with the internal pipe 11 after passing between the other cap 15 and the external pipe 13, and it is preferable to prevent various electricity safety accidents, such as an electric shock or leakage, and a fluid leakage problem by adopting the appropriate sealing body S between the respective electrodes 23 and 25 and other constituent elements.

A coupling structure of the cap 15 and the internal and external pipes 11 and 13 or the structure of the sealing body may be variously modified considering performance, safety, productivity, and the like.

In the plasma advanced water treatment apparatus T according to the present invention, a sterilizing effect by ultraviolet rays generated according to the plasma discharge may also be expected.

Further, in the plasma advanced water treatment apparatus T according to the present invention, a plurality of dielectric beads 17 may be filled in the internal pipe 11 of the double pipe 10, that is, the first passage 11A. The dielectric beads randomly move by colliding with water according to a passage of the water-to-be-treated to generate stable potential within the first passage, thereby serving to more effectively remove various bacteria or various pathogenic bacteria.

The dielectric beads are formed of ceramic, particularly, publicly known functional ceramic, such as zirconium, titanium, alumina, or a composite material, to serve both a stable potential generation function within the first passage and a unique function of a ceramic material, such as far infrared ray and ultraviolet ray radiation, odor removal, and adsorption.

As illustrated in FIG. 2, the water tank 30 may be connected with several tens or several hundreds of double pipes, not with one or two double pipes 10, according to a scale of the water treatment (6 double pipes are illustrated in the drawing for convenience), and it is preferable that the plasma advanced water treatment system is formed by adopting a plurality of water tanks, so that the concept of the present invention is expanded from a small scale water treatment for home to a large-scale water treatment for a water supply.

Further, a circulation pipe 31 and a circulation pump 33 may be further connected with and adopted to the water tank 30, particularly, a treated water inflow water tank 30B of a left side of the water tank 30, so that water, which passes through the double pipe 10 or a double pipe assembly, other than a treated water discharge pipe 35, reacts with the radical generation source in the water tank and then is subjected to the plasma discharge process again.

A quantity, and a discharge-supply/residence ratio of the water circulating the double pipe 10 or the double pipe assembly and the water tank 30 through the circulation pipe 31 may be selected considering a contamination degree of the water-to-be-treated or a requirement of a water quality of the treated water.

Further, it is illustrated in FIG. 1 that a plasma processing assembly T1 formed of the double pipe 10 and the plasma generating means 20 is disposed in one column, but may be disposed in two or more columns to promote multiprocessing, and the water tanks, in which the radical generation source, such as ozone, and the water-to-be-treated react with each other, may also be multi-arranged in two or more columns as necessary.

Next, as illustrated in FIGS. 2 and 1, the plasma advanced water treatment apparatus T according to the present invention adopts a microbubble generating means to promote a remarkably improvement of water treatment efficiency by improving efficiency of a contact between the water-to-be-treated and the radical generation source, such as ozone, in the water tank 30, and improving efficiency of dissolution of the radical generation source.

First, the first microbubble generating means B1 includes a combined pipe 41 connected with the respective outlets 11b and 13b of the first passage 11 and the second passage 13 of the double pipe 10, and a pump 43 disposed between the combined pipe 41 and the water tank 30, and more particularly, the outlet 11b is connected with a treated water pipe 41a and the outlet 13b is connected with an ozone discharge pipe 41b to be combined at the combined pipe 41, so that the treated water flows in the water tank, particularly, the treated water inflow tank 30B, by absorptive power of the pump 43.

In the meantime, the water source W of the water supply source, tap water, and the waste water treatment facility supplying the water-to-be-treated into the internal pipe 11 of the double pipe 10 may be directly connected through the pipe, but in the present invention, but in the present invention, in order to guarantee continuous and stable supply of the water-to-be-treated and improve water treatment efficiency, one water tank 30 is divided into the treated water inflow tank 30B and a water-to-be-treated inflow tank 30A, and the combined pipe 41 is connected to the treated water inflow tank 30B so that the treated water reacts with the radical generation source in the treated water inflow tank 30B, and the water-to-be-treated inflow tank 30A is provided next to the treated water inflow tank 30B, so that various water-to-be-treated flows in the water-to-be-treated inflow tank 30A from the water source W.

The water-to-be-treated of the water-to-be-treated inflow tank 30A is pumped by the circulation pump 33 to be supplied to the double pipe 10 of the plasma treatment assembly T1 via the circulation pipe 31.

Further, as necessary, a valve V2 is provided on a partition wall between the treated water inflow tank 30B and the water-to-be-treated inflow tank 30A, and the treated water is repeatedly circulated in a state where a valve V1 provided at the water source W is closed or opened (or partially opened) in an opened state of the valve V2, so that it is possible to improve water treatment efficiency.

The partition wall between the treated water inflow tank 30B and the water-to-be-treated inflow tank 30A is not essential (accordingly, the configuration in which the treated water inflow tank 30B and the water-to-be-treated inflow tank 30A are arranged in one water tank 30 is illustrative), and the two physically divided water tanks include first and second water tanks, and the two water tanks are connected through a pipe, and a form in which the pipe adopt a valve is also available.

A second microbubble generating means B2 operable together with a first microbubble generating means B1 or independently operable includes the circulation pipe 31, the circulation pump 33, and the ozone discharge pipe 31b.

When a valve V3a provided at a pipe 31a connected with the water-to-be-treated inflow tank 30A is opened in a state where an ozone valve V1a of the ozone discharge pipe 41b of the first microbubble generating means B1 is closed and a valve V1b of the ozone discharge pipe 31b of the second microbubble generating means B2 is opened when the second microbubble generating means B2 is independently operated, the water-to-be-treated is combined at the circulation pipe 31 by the circulation pump 33, so that the water-to-be-treated containing the microbubble is supplied to the internal pipe 11 of the double pipe 10 of the plasma treatment assembly T1.

Above all, the second microbubble generating means B2 may increase a quantity of dissolved oxygen because the bubbles are split to have a smaller size while colliding with the dielectric beads 17, and efficiency of various water treatments is improved by the microbubble.

The “circulation pipe 31” forming the second microbubble generating means B2 serves the same function as that of the “combined pipe 41” of the first microbubble generating means B 1, and is fundamentally connected with the respective outlets 11b and 13b of the first passage 11 and the second passage 13, and the pump 33 is disposed between the “circulation pipe 31” serving as the combined pipe and the water-to-be-treated inflow tank 30A, which thus corresponds to the scope described in claim 3.

In the meantime, in order to improve efficiency of the contact between the water-to-be-treated and the radical generation source and improve efficiency of the water treatment, an impeller-typed agitator or various aeration tubes may be further provided to the water tank as necessary.

Further, a valve V may be further provided at a pipe connecting each of the water source W and a gas supply source A with the double pipe 10 or necessary portions of other pipes.

Further, the control of the power supply unit 21, the pumps 33 and 43, and the various valves V, V1, V1a, V1b, V2, V3a, and V3b (provided at the treated water discharge pipe 35 so as to be used at a final discharge of the treated water) may be semi-automatically or automatically performed by a controller formed of various microcoms, a programmable logic controller, and the like.

Next, a plasma advanced water treatment apparatus according to another embodiment of the present invention will be described with reference to FIGS. 3 to 6.

In order to avoid complexity of illustration, connection lines between a plurality of thermostats S2 and the plasma generating means 20 are omitted in FIG. 4, connection lines between the plurality of thermostats S1 and the plasma generating means 20 in a case where the plurality of double pipes 10 is installed are illustrated in FIG. 6, and the plurality of thermostats S1 is serially connected with the plasma generating means 20 in a case where the plurality of thermostats S1 is included as illustrated in FIG. 6, and according to the configuration in which the plurality of thermostats S1 is serially connected with the plasma generating means 20, when any one of the double pipes 10 reaches a predetermined temperature, a power supply is blocked.

As illustrated in the drawings, the plasma advanced water treatment apparatus according to another embodiment of the present invention is characterized in that both ends of the internal pipe 11 is opened, and there is further provided a spacer 16 spaced apart from both ends of the internal pipe 11 to a center portion of the internal pipe 11 to be in close contact with an interior circumferential surface of the internal pipe 11 to allow the water-to-be-treated flowing the first passage 11A to pass through, but to block the dielectric beads 17 from passing through so as to prevent the dielectric beads 17 from leaking from the internal pipe 11.

According to the configuration, it is not necessary to seal both ends of the internal pipe 11 to improve workability for filling the internal pipe 11 with the dielectric beads 17 and workability of assembling a product, and it is advantageously possible to freely set a space for filling the internal pipe 11 with the dielectric beads 17 by the spacers 16.

As illustrated in FIG. 5, the spacer 16 includes a body part 16a shaped like a circular pipe so as to be in close contact with the interior circumferential surface of the internal pipe 11, and a mesh portion 16b shaped like a net so as to allow the water-to-be-treated to pass through, but to block the dielectric beads 17 from passing through and provided at a front end of the body part 16a in a water flow direction.

Accordingly, a size of a through-hole 16b′ of the mesh portion 16b is determined so as to allow the water-to-be-treated (and the treated water) to pass through, but to block the dielectric beads 17 from passing through.

Further, an electrode fixing hole 16c for holding a central electrode 23 disposed at the internal pipe 11 is formed at a center of the mesh portion 16b, which has an advantage in that it is possible to prevent the electrode 23 from being shaken or moving even though the water-to-be-treated passes through.

Further, the spacer 16 is formed of a plastic resin material, a rear end 16a′ of the body part 16a is formed to be slightly larger than the front end, and incision recesses 16d are formed at the rear end 16a′ side, so that close contact in a case where the spacer 16 is inserted into the internal surface of the internal pipe 11 is advantageously enhanced.

The plasma advanced water treatment apparatus according to another embodiment of the present invention is characterized by further including a first hose h1 having one end provided at the inlet 11a and the other end positioned at the spacer 16 so as to allow the water-to-be-treated flowing into the inlet 11a connected with the water source W to smoothly flow into the internal pipe 11, and a second hose h2 having one end positioned at the spacer 16 and the other end provided at the outlet 11b so as to allow the water-to-be-treated passing through the internal pipe 11 to be smoothly discharged to the outlet 11b.

According to the configuration, the water-to-be-treated is supplied through the hoses h1 and h2, and the treated water is discharged through the hoses, so that it is possible to decrease fluid resistance by the dielectric beads 17, thereby advantageously smoothly supplying the water-to-be-treated.

The plasma advanced water treatment apparatus according to another embodiment of the present invention is characterized in that the inlet 13a connected with the gas supply source A supplying the radical reaction gas and the outlet 13b through which the radical generation source generated by plasma discharging the radical reaction gas flowing in through the inlet 13a are formed at the cap 15, the plurality of double pipes 10 is provided in parallel, and an insert 18, through which an orifice 18a passes, is installed at the inlet 13a so that the supplied radical reaction gas is uniformly supplied to the plurality of inlets 13a formed at the plurality of double pipes 10 in a case where the radical reaction gas is simultaneously supplied to the plurality of double pipes 10 from one gas supply source A.

Even though the radical reaction gas is simultaneously supplied to the plurality of double pipes 10, the radical reaction gas is supplied through the orifice 18a formed at each double pipe 10, so that it is advantageously possible to uniformly supply the radical reaction gas to the respective double pipes 10.

The insert 18 may also be integrally formed with the inlet 13a, and may also be formed as a configuration separated from the inlet 13a.

The plasma advanced water treatment apparatus according to another embodiment of the present invention is characterized by including the thermostat S1, which is installed at one side of the double pipe 10 and serially connected to any one between the electrodes 23 and 25 of the plasma generating means 20, so that when the double pipe 10 has a predetermined temperature or higher, the thermostat S1 is opened, to block the power supply of the power supply unit 21.

According to the configuration, when the double pipe 10 has the predetermined temperature or higher, the power supply is blocked by the thermostat S 1, so that it is possible to prevent fire due to overheating of the double pipe 10.

Next, the configuration of the double pipe 10 illustrated in FIGS. 3 and 4 will be described based on a difference from that of the embodiment illustrated in FIGS. 1 and 2.

As illustrated in FIGS. 3 and 4, the internal pipe 11 is in external contact with a fitting recess 15a of each cap 15, and a packing ring may be provided between the fitting portion 15A and the internal pipe 11 as necessary. Further, the external pipe 13 has a form being in internal contact with each cap 15.

Further, the outlet 13b through which the radical generation source is discharged is preferably formed at a side orthogonally opposite to the inlet 13a through which the radical reaction gas is supplied. Accordingly, the water-to-be-treated passes through the entire second passage 13A, so that efficiency of the generation of the radical generation source is improved.

Next, a plasma advanced water treatment apparatus according to yet another embodiment of the present invention will be described based on FIGS. 7 to 10.

Connection lines between a plurality of leakage detecting sensors 61 are omitted in FIG. 9 in order to avoid complexity in illustration, connection lines between the plurality of leakage detecting sensors 61 in a case where the plurality of double pipes 10 is installed are illustrated in FIG. 10, and as illustrated in FIG. 10, when the plurality of leakage detecting sensors 61 is provided, the plurality of leakage detecting sensors 61 is connected with each other in parallel.

As illustrated in the drawings, the plasma advanced water treatment apparatus according to yet another embodiment of the present invention includes the leakage detecting sensor 61 provided at one side of the double pipe 10 to detect a leakage of the water-to-be-treated flowing through the internal pipe 11 to the second passage 13A, and an output stop control circuit unit 63 for stopping high-voltage output of the power supply unit 21 by stopping driving of a power driving circuit 21a in a case where the leakage detecting sensor 61 detects the water-to-be-treated leaking into the second passage 13A (in a case where a short-circuit current flows in the leakage detecting sensor 61 because the water-to-be-treated leaks into the second passage 13A).

The power driving circuit 21a is provided inside the power supply unit 21 to generate a high alternating current voltage, and may be formed as, for example, an inverter.

According to the configuration, the water-to-be-treated of the internal pipe 11 flows out when the internal pipe 11 is damaged due to high-voltage plasma discharge in the structure of the double pipe 10 for the plasma discharge, and the flowing-out water-to-be-treated is detected, so that an operation of the power supply unit 21 is stopped.

It is possible to immediately stop the operation of the power supply unit when the internal pipe 11 is damaged due to the high voltage, thereby achieving an effect of preventing fire or electric shock due to a destruction of a discharge tube.

Further, even though the discharge tube is not damaged, in a case where water-tightness of the double pipe 10, especially, the internal pipe 11, is poor, the water-to-be-treated may leak, but it is also possible to detect the leakage due to the poor water-tightness, so that it is possible to promptly recognize a defect of a product, thereby efficiently and easily repairing and managing the water treatment apparatus.

The plasma advanced water treatment apparatus according to yet another embodiment of the present invention is characterized in that the leakage detecting sensor 61 is formed of a pair of electrodes 61, and there is further provided a photocoupler 62, which applies an insulated voltage Vs to the leakage detecting sensor 61, is connected between the leakage detecting sensor 61 and the output stop control circuit unit 63, and receives a short circuit current Is of the leakage detecting sensor 61 to output an operation control signal to the output stop control circuit unit 63 in a case where the water-to-be-treated leaks into the second passage 13A so that the short circuit current flows in the leakage detecting sensor 61.

In the plasma advanced water treatment apparatus according to yet another embodiment of the present invention, a sensor voltage supply unit 64 is connected to one terminal of the pair of electrodes 61, and the sensor voltage supply unit 64 includes a transformer Tm for stepping down the voltage applied from an alternating current power source, and a rectification diode D1 for rectifying the AC current of the transformer Tm, and thus it is advantageously possible to apply the insulated voltage through the configuration.

The insulated power source voltage is supplied to the leakage detecting sensor 61, and the photocoupler 62 is provided between the leakage detecting sensor 61 and the output stop control circuit unit 63, so that the current is insulated in the transformer Tm and the photocoupler 62 (both the photocoupler 62 and the transformer Tm adopt a common ground AGND), thereby advantageously preventing the high plasma discharge voltage applied to the double pipe 10 from flowing into the power supply unit 21.

In the plasma advanced water treatment apparatus according to yet another embodiment of the present invention, the double pipes 10 are vertically disposed so that the water-to-be-treated flows from top to bottom, and the internal pipe 13 and the external pipe 13 are fixed while being spaced apart from each other by the pair of caps 15, and the leakage detecting sensor 61 is installed at the lower cap 15 so that an upper end of the leakage detecting sensor 61 is positioned at the second passage 13A.

Contrary to the present invention, if the double pipes 10 are not vertically arranged as described in the present invention, but are horizontally arranged, in a case where the internal pipe 11 is damaged due to a high voltage, there incurs a severe problem that water contained in the internal pipe 11 flows backward to the gas supply source A (for example, an oxygen generator) through the inlet 13a, and the flowing backward water may flow toward the adjacent double pipe 10.

However, according to the aforementioned configuration, the leakage detecting sensor 61 may promptly detect the water, which flows out due to the destruction of the internal pipe 11 or leaks due to poor water-tightness, without an error, and further may prevent the water-to-be-treated existing in the internal pipe from flowing backward to the gas supply source A1 for radical reaction even though the internal pipe 11 is damaged.

In the plasma advanced water treatment apparatus according to yet another embodiment of the present invention, the output stop control circuit unit 63 includes a comparator 63a for outputting a high signal of a logic signal when an output signal is not received from the photocoupler 62, and outputting a low signal of the logic signal when the output signal is received in an input terminal from the photocoupler 62, and a microcom 63b for outputting a driving control signal for operating the power driving circuit 21a included in the power supply unit 21 when the high signal of the logic signal is received from the comparator 63a, and outputting a driving stop control signal for stopping the operation of the power driving circuit 21a to the power driving circuit 21a when the low signal of the logic signal is received from the comparator 63a.

When the power driving circuit 21a is formed as the inverter as described above, the driving stop control signal shuts down an inverter frequency driving IC to stop the driving of the inverter.

Next, a leakage detecting operation of the plasma advanced water treatment apparatus according to yet another embodiment of the present invention including the aforementioned configuration will be described.

In a case where the water-to-be-treated does not spill out or the internal pipe 11 does not have the leakage because the internal pipe 11 is not damaged, two terminals of the leakage detecting sensor 61 are opened, the current does not flow to the photocoupler 62, and the current signal is not input to the input terminal of the comparator 63a, so that the comparator 63a transmits the low signal of the logic signal, the microcom 63b outputs the low signal of the logic signal to the power driving circuit 21a, and the power driving circuit 21a is operated so that the power supply unit 21 continuously generates the high voltage output.

However, in a case where the water-to-be treated spills out due to the destruction of the internal pipe 11 or the leakage is generated in the internal pipe 11, the leakage detecting sensor 61 is short-circuited and the short-circuit current Is flows by the voltage Vs applied to the secondary winding of the transformer Tm, the short-circuit current Is is input to the photocoupler 62, the photocoupler 62 transmits the output current to the input terminal of the comparator 63a by the input short-circuit current Is, the comparator 63a outputs the high signal of the logic signal to the microcom 63b, the microcom 63b receiving the high signal of the logic signal outputs the driving stop control signal to the power driving circuit 21a, the operation of the power driving circuit 21a receiving the driving stop control signal is stopped, and as a result, the power supply unit 21 stops the output of the power.

In the present specification, the naming of the microbubble generating means and the water tanks with “the first ˜” and “the second ˜” is for the purpose of discriminating the microbubble generating means and the water tanks from each other, and has nothing to do with significance or a manufacturing order, and especially, for the convenience, “a first ˜”, “a second ˜”, and the like are added for description when the elements are compared to be described.

Further, in the present specification, the “treated water” and the “water-to-be-treated”are not strictly named, and approximately, when the water flows into the plasma processing assembly T1, the water is called the “water-to-be-treated”, and when the water is discharged from the plasma processing assembly T1, the water is called the “treated water”.

In the above description, the general publicly-known techniques related to a plasma generating method and a mechanism thereof, a particular specification of the power supply unit, a particular specification of the electrode, specifications of the pumps, a processing capacity, and the control method are omitted, but those skilled in the art may easily guess, infer, reproduce the same.

Further, in the above description of the present invention, the plasma advanced water treatment apparatus having the specific shape and structure is mainly described with reference to the accompanying drawings, but the present invention may be variously corrected, modified, and substituted by those skilled in the art, and it will be construed that the correction, the modification, and the substitution belong to the scope of the present invention.

1. A plasma advanced water treatment apparatus, comprising:
a double pipe (10) having a first passage (11A) for treated water and a second passage (13A) for radical reaction gas, which are separated from each other;
a plasma generating means (20) including electrodes (23 and 25) arranged at the first and second passages (11A and 13A) of the double pipe (10), and a power supply unit (21) connected with the electrodes (23 and 25); and
a water tank (30) connected with the double pipe (10) so that the treated water and a radical generation source react with each other.

2. The plasma advanced water treatment apparatus of claim 1, wherein the first passage (11A) of the double pipe (10) is filled with a plurality of dielectric beads (17) generating stable potential within the first passage (11A) while randomly moving according to a passage of the treated water.

3. The plasma advanced water treatment apparatus of claim 1, further comprising:
a combined pipe connected with outlets (11B and 13B) of the first passage (11A) and the second passage (13A) of the double pipe (10); and
a microbubble generating means formed of a pump disposed between the combined pipe and the water tank.

4. The plasma advanced water treatment apparatus of claim 1, wherein the first passage (11A) of the double pipe (10) is an internal passage surrounded by an internal pipe (11), and the second passage (13A) is disposed between the internal pipe (11) and an external pipe (13), and
the electrode (25) disposed in the second passage (13A) has a coil or mesh shape.

5. The plasma advanced water treatment apparatus of claim 2, wherein the first passage (11A) of the double pipe (10) is an internal passage surrounded by an internal pipe (11), the second passage (13A) is formed between the internal pipe (11) and an external pipe (13), and both ends of the internal pipe (11) are opened, and the plasma advanced water treatment apparatus further comprises a spacer (16) installed while being spaced from the both ends of the internal pipe (11) to a center portion thereof to be in close contact with an interior circumferential surface of the internal pipe (11) to allow the water-to-be-treated flowing through the first passage (11A) to pass through, but to block the dielectric beads (17) from passing through so as to prevent the dielectric beads (17) from slipping out the internal pipe (11).

6. The plasma advanced water treatment apparatus of claim 5, wherein the internal pipe (11) and the external pipe (13) are spaced apart from each other to be fixed by a pair of caps (15), and
the caps (15) are provided with an inlet (11a) connected with a water source (W) and an outlet (11b) through which the water-to-be-treated flowing in through the inlet (11a) and passing through the first passage (11A) is discharged from the double pipe (10), and
the plasma advanced water treatment apparatus further comprises:
a first hose (h1) having one end provided at the inlet (11a) and the other end positioned at the spacer (16) so that the water-to-be-treated flowing in through the inlet (11a) smoothly flows in the internal pipe (11); and
a second hose (h2) having one end positioned at the spacer (16) and the other end provided at the outlet (11b) so that the water-to-be-treated passing through the internal pipe (11) is smoothly discharged through the outlet (11b).

7. The plasma advanced water treatment apparatus of claim 6, wherein the caps (15) are provided with an inlet (13a) connected with a gas supply source (A) supplying the radical reaction gas, and an outlet (13b) for discharging a radical generation source generated by plasma discharging the radical reaction gas flowing in through the inlet (13a),
a plurality of double pipes (10) is provided, and
an insert (18), through which an orifice (18a) passes, is installed at the inlet (13a) so that the supplied radical reaction gas is evenly supplied to the plurality of inlets (13a) formed at the plurality of double pipes (10) in a case where one gas supply source (A) simultaneously supplies the radical reaction gas to the plurality of double pipes (10).

8. The plasma advanced water treatment apparatus of claim 1, comprising a thermostat (S1) installed at one side of the double pipe (10) and serially connected to any one of the electrodes (23 and 25) of the plasma generating means (20) to be opened in a case where the double pipe (10) has a predetermined temperature or higher, to block a power supply of the power supply unit (21).

9. The plasma advanced water treatment apparatus of claim 1, wherein the first passage (11A) of the double pipe (10) is an internal passage surrounded by an internal pipe (11), and the second passage (13A) is formed between the internal pipe (11) and an external pipe (13), and
the plasma advanced water treatment apparatus further comprises:
a leakage detecting sensor (61) provided at one side of the double pipe (10) to detect a leakage of the water-to-be-treated flowing through the internal pipe (11) to the second passage (13A); and
an output stop control circuit unit (63) configured to stop high-pressure output of the power supply (21) by stopping a driving of a power driving circuit (21a) in a case where the leakage detecting sensor (61) detects the water-to-be-treated leaking to the second passage (13A).

10. The plasma advanced water treatment apparatus of claim 9, wherein the leakage detecting sensor (61) is formed of a pair of electrodes (61), and an insulated voltage Vs is applied to the leakage detecting sensor (61), and
the plasma advanced water treatment apparatus further comprises:
a photocoupler (62) connected between the leakage detecting sensor (61) and the output stop control circuit unit (63), and configured to output an operation control signal to the output stop control circuit unit (63) by receiving a short-circuit current (Is) of the leakage detecting sensor (61).

11. The plasma advanced water treatment apparatus of claim 9, wherein the double pipes (10) are vertically arranged so that the water-to-be-treated flows from top to bottom,
the internal pipe (11) and the external pipe (13) are spaced apart from each other and fixed by a pair of caps (15), and
the leakage detecting sensor (61) is installed at the lower cap (15) so that an upper end thereof is positioned at the second passage (13A).
